(19) United States
(12) Patent Application Publication
(10) Pub. No.: US 2026/0352466 A1
(43) Pub. Date: Nov. 5, 2026

(54) CRYPTOGRAPHIC PROCESSING METHOD, NON-TRANSITORY RECORDING MEDIUM STORING PROGRAM, AND CRYPTOGRAPHIC PROCESSING SYSTEM

(71) Applicant: Panasonic Intellectual Property Management Co., Ltd., Osaka (JP)

(72) Inventors: YASUSHI TAKAHASHI, Fukuoka (JP); NAOHISA NISHIDA, Kanagawa (JP); YUJI UNAGAMI, Osaka (JP); SABURO TOYONAGA, Fukuoka (JP)

(21) Appl. No.: 19/713,917

(22) Filed: Jun. 19, 2026

Related U.S. Application Data
(63) Continuation of application No. PCT/JP2024/029932, filed on Aug. 23, 2024.
(60) Provisional application No. 63/618,014, filed on Jan. 5, 2024.

(30) Foreign Application Priority Data
May 24, 2024 (JP) 2024-085112

(51) Int. Cl. H04L 9/30

(52) U.S. Cl. CPC H04L 9/3093

(57) ABSTRACT

A cryptographic processing method includes storing a first intermediate parameter, which is a portion of intermediate parameters used in a process of executing an algorithm using lattice-based cryptography, in an internal storage included in a device (IoT device), and in a case where the algorithm is executed, executing the algorithm by using a second intermediate parameter, which is a remaining portion of the intermediate parameters other than the first intermediate parameter, and the first intermediate parameter read from the internal storage.

### BACKGROUND

### 1. Technical Field

The present disclosure relates to a cryptographic processing method, a non-transitory recording medium storing a program, and a cryptographic processing system.

### 2. Description of the Related Art

Shi Bai, et al., CRYSTALS-Dilithium Algorithm Specifications and Supporting Documentation (Version 3.1), February 2021 discloses CRYSTALS-Dilithium, which is one kind of a cryptographic technology.

Denisa O. C. Greconici, et al., Compact Dilithium Implementations on Cortex-M3 and Cortex-M4, IACR Transactions on Cryptographic Hardware and Embedded Systems, Vol. 2021, No. 1, pp. 1-24 (hereinafter referred to as Denisa) discloses Dilithium, which is one kind of a cryptographic technology.

### SUMMARY

One non-limiting and exemplary embodiment provides a cryptographic processing method and others that make it easy to reduce a usage amount of an internal storage device included in a device in a case where lattice-based cryptography is used.

In one general aspect, the techniques disclosed here feature a cryptographic processing method including storing a first intermediate parameter, which is a portion of intermediate parameters used in a process of executing an algorithm using lattice-based cryptography, in an internal storage device included in a device; and in a case where the algorithm is executed, executing the algorithm by using a second intermediate parameter, which is a remaining portion of the intermediate parameters other than the first intermediate parameter, and the first intermediate parameter read from the internal storage device.

The present disclosure is advantageous in that it is easy to reduce a usage amount of an internal storage device included in a device in a case where an algorithm using lattice-based cryptography is executed.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is an explanatory view for explaining a problem that occurs in a case where lattice-based cryptography is used in an IoT device;

FIG. 2 is an explanatory view for explaining a problem that occurs in a case where lattice-based cryptography is used in an IoT device according to means disclosed in Denisa;

FIGS. 3A and 3B are views for explaining an outline of a cryptographic processing method according to an embodiment;

FIG. 4 is a view for explaining an outline of classification and division of intermediate parameters;

FIG. 5 is a view for explaining an outline of preprocessing;

FIG. 6 is a block diagram illustrating an example of a functional configuration of a table creation device according to the embodiment;

FIGS. 7A to 7D illustrate an example of an intermediate parameter table;

FIG. 8 illustrates an example of a processing time upper limit table;

FIG. 9 is a block diagram illustrating an example of a functional configuration of an IoT device according to the embodiment;

FIG. 10 is a block diagram illustrating an example of a functional configuration of a cryptographic processing system according to the embodiment;

FIG. 11 is a block diagram illustrating an example of a functional configuration of a signature generation device according to the embodiment;

FIG. 12 is a sequence diagram illustrating a first example of operation of the IoT device according to the embodiment; and

FIG. 13 is a sequence diagram illustrating a second example of operation of the IoT device according to the embodiment.

### DETAILED DESCRIPTIONS

### Underlying Knowledge Forming Basis of the Present Disclosure

Lattice-based cryptography is known as one of public-key cryptography methods. The lattice-based cryptography has advantages such as having quantum resistance and fully homomorphic capability as compared with other cryptography methods such as Rivest-Shamir-Adleman (RSA) and Elliptic Curve Digital Signature Algorithm (ECDSA). On the other hand, the lattice-based cryptography requires a high processing load during use, especially requires a large usage amount of a memory such as a Static Random Access Memory (SRAM) or a Dynamic Random Access Memory (DRAM), and therefore poses a problem that it is hard to apply the lattice-based cryptography to an Internet of Things (IoT) device having a relatively small memory capacity.

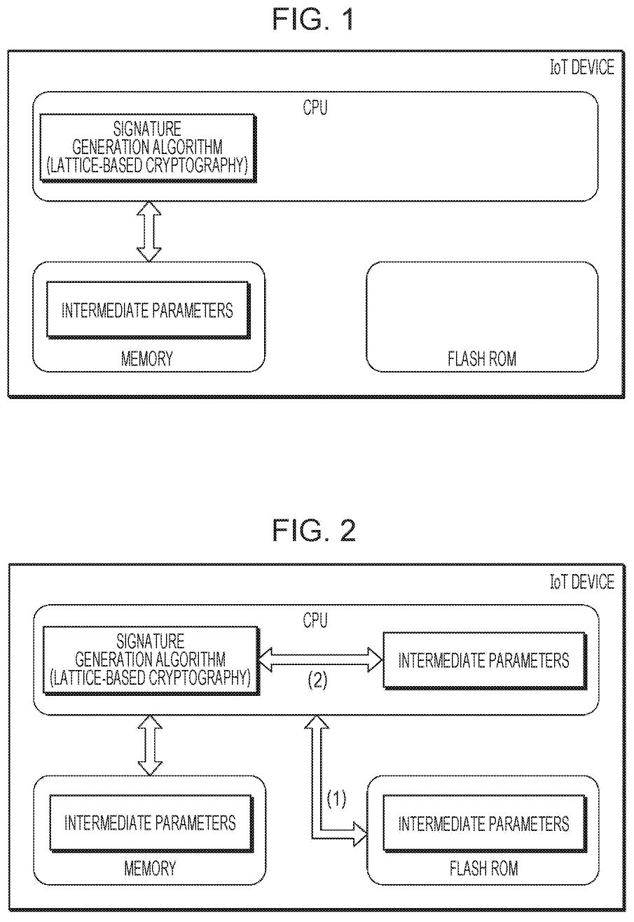

FIG. 1 is an explanatory view for explaining a problem that occurs in a case where the lattice-based cryptography is used in an IoT device. In the example illustrated in FIG. 1, the IoT device includes a central processing unit (CPU), a memory, and a flash read only memory (ROM). The memory is an internal storage device built in the IoT device, and the flash ROM is an external storage device connected to the IoT device. In a case where the lattice-based cryptography is used in the IoT device, the CPU performs processing for generating intermediate parameters when executing a signature generation algorithm or a signature verification algorithm for the first time in the IoT device according to standard means.

The intermediate parameters are parameters generated in the algorithm and are values used in a process of calculating an output value by using an input value in the algorithm. The input value is, for example, a private key, a public key, a seed value, or the like. The intermediate parameters are represented by a matrix having elements that are polynomials over a finite field, as described later. Different intermediate parameters are used in the signature generation algorithm and the signature verification algorithm. That is, the intermediate parameters include parameters for the signature generation algorithm and parameters for the signature verification algorithm.

The intermediate parameters generated by the CPU are stored in the memory (internal storage device). When executing the signature generation algorithm or the signature verification algorithm, the CPU reads out intermediate parameters corresponding to the algorithm from the memory and thus uses the intermediate parameters. Therefore, according to the standard means, the intermediate parameters that require a large memory usage amount need to be stored in the memory, and it is therefore difficult to use the lattice-based cryptography in the IoT device having a relatively small storage capacity.

Although means to solve the above problem of the standard means is disclosed in Denisa, the means disclosed in Denisa still cannot solve the problem that occurs in a case where the lattice-based cryptography is used in an IoT device. FIG. 2 is an explanatory view for explaining a problem of the means disclosed in Denisa that occurs in a case where the lattice-based cryptography is used in an IoT device. As means to solve the above problem of the standard means, Denisa discloses first means (see (1) of FIG. 2) and second means (see (2) of FIG. 2).

According to the first means, the CPU causes intermediate parameters generated in advance when executing a signature generation algorithm or a signature verification algorithm to be stored in a flash ROM (external storage device) instead of a memory (internal storage device). Therefore, according to the first means, the intermediate parameters can be stored in the flash ROM whose restriction on a storage capacity is less strict than the memory, and the intermediate parameters need not be stored in the memory.

According to the second means, the CPU generates intermediate parameters from a seed value every time the CPU executes the signature generation algorithm or the signature verification algorithm. Therefore, according to the second means, the intermediate parameters need not be stored in the memory.

However, according to the first means and the second means, another problem as described below occurs. Specifically, according to the first means, the intermediate parameters stored in the flash ROM (external storage device) include, for example, information on a private key of a signer. Therefore, the first means has a problem that resistance against information leakage is poorer than the standard means in which intermediate parameters are stored in the memory (internal storage device). Note that measures such as preparing a storage region using TrustZone (Registered Trademark) in the flash ROM may be taken to increase resistance against information leakage. This, however, undesirably tends to invite an increase in cost.

According to the second means, intermediate parameters need to be generated every time the signature generation algorithm or the signature verification algorithm is executed. This undesirably tends to increase a processing load on the CPU and prolong a processing time.

In view of the above circumstances, an object of the present disclosure is to provide a cryptographic processing method and others that make it easy to reduce a memory usage amount by storing only a portion of intermediate parameters in a memory (internal storage device) in a case where lattice-based cryptography is used.

More specifically, a cryptographic processing method according to a first aspect of the present disclosure includes storing a first intermediate parameter, which is a portion of intermediate parameters used in a process of executing an algorithm using lattice-based cryptography, in an internal storage included in a device; and in a case where the algorithm is executed, executing the algorithm by using a second intermediate parameter, which is a remaining portion of the intermediate parameters other than the first intermediate parameter, and the first intermediate parameter read from the internal storage.

According to this, only a portion (the first intermediate parameter) of the intermediate parameters is stored in the internal storage device instead of storing all the intermediate parameters in the internal storage device. This is advantageous in that it is easy to reduce a usage amount of the internal storage device included in the device in a case where the algorithm using the lattice-based cryptography is executed.

For example, a cryptographic processing method according to a second aspect of the present disclosure is the cryptographic processing method according to the first aspect, in which the intermediate parameters are represented by a matrix having elements that are polynomials over a finite field and include parameters classified on the basis of the number of rows or the number of columns, and the first intermediate parameter includes a parameter classified from among the parameters.

According to this, the intermediate parameters represented by a matrix are classified into the first intermediate parameter and the second intermediate parameter. This is advantageous in that it is easy to execute the algorithm since it is easy to handle the first intermediate parameter and the second intermediate parameter as the original intermediate parameters when executing the algorithm.

For example, a cryptographic processing method according to a third aspect of the present disclosure is the cryptographic processing method according to the first aspect, in which the intermediate parameters are represented by a matrix having elements that are polynomials over a finite field, and the first intermediate parameter includes a parameter having a predetermined number of rows or columns obtained by dividing the matrix representing the intermediate parameters.

According to this, the intermediate parameters represented by a matrix are divided into the first intermediate parameter and the second intermediate parameter. This is advantageous in that it is easy to execute the algorithm since it is easy to handle the first intermediate parameter and the second intermediate parameter as the original intermediate parameters when executing the algorithm.

For example, a cryptographic processing method according to a fourth aspect of the present disclosure is the cryptographic processing method according to any one of the first to third aspects, further including storing the second intermediate parameter in an external storage connected to the device, in which in the case where the algorithm is executed, the second intermediate parameter is read from the external storage.

According to this, a parameter for which information leakage is not permitted such as information on a private key of a signer among the intermediate parameters can be stored in the internal storage device, and a remaining parameter can be stored in the external storage device. This is advantageous in that it is easy to improve resistance against information leakage while reducing a usage amount of the internal storage device.

For example, a cryptographic processing method according to a fifth aspect of the present disclosure is the cryptographic processing method according to any one of the first to third aspects, in which in the case where the algorithm is executed, the second intermediate parameter is generated by calculation.

According to this, only a portion of the intermediate parameters is calculated when executing the algorithm instead of calculating all the intermediate parameters. This is advantageous in that it is easy to shorten a processing time of processing for calculating the intermediate parameter while reducing a usage amount of the internal storage device.

For example, a cryptographic processing method according to a sixth aspect of the present disclosure is the cryptographic processing method according to any one of the first to fifth aspects, further including determining the first intermediate parameter and the second intermediate parameter on the basis of a processing capability of the device and an available storage capacity of the internal storage.

According to this, the first intermediate parameter and the second intermediate parameter are determined in accordance with the capability of the device. This is advantageous in that it is easy to store an appropriate amount of the first intermediate parameter in the internal storage device of the device.

For example, a cryptographic processing method according to a seventh aspect of the present disclosure is the cryptographic processing method according to the sixth aspect, in which the first intermediate parameter and the second intermediate parameter are determined by referring to an intermediate parameter table. The intermediate parameter table shows a correlation between an amount of the portion of the intermediate parameters stored in either the internal storage device or an external storage connected to the device, and a usage amount of the internal storage used to execute the algorithm and a processing time required to execute the algorithm.

According to this, the first intermediate parameter and the second intermediate parameter are determined by referring to the intermediate parameter table according to the capability of the device. This is advantageous in that it is easy to store an appropriate amount of the first intermediate parameter in the internal storage device of the device.

For example, a cryptographic processing method according to an eighth aspect of the present disclosure is the cryptographic processing method according to the seventh aspect, further including determining a maximum amount of the parameter storable in either the internal storage or the external storage on the basis of at least one of an intended purpose of the device, a use environment of the device, or security requirements indicative of a level of security requested for the device; and creating the intermediate parameter table on the basis of the determined maximum amount of the parameter.

According to this, the intermediate parameter table is created according to the specifications of the device. This is advantageous in that it is easy to store an appropriate amount of the first intermediate parameter in the internal storage device of the device.

For example, a non-transitory recording medium storing a program according to a ninth aspect of the present disclosure stores a program causing one or more processors to execute the cryptographic processing method according to any one of the first to eighth aspects.

According to this, only a portion (the first intermediate parameter) of the intermediate parameters is stored in the internal storage device instead of storing all the intermediate parameters in the internal storage device. This is advantageous in that it is easy to reduce a usage amount of the internal storage device included in the device in a case where the algorithm using lattice-based cryptography is executed.

For example, a cryptographic processing system according to a tenth aspect of the present disclosure includes an internal storage and a processor. The processor performs operations including: storing a first intermediate parameter, which is a portion of intermediate parameters used in a process of executing an algorithm using lattice-based cryptography, in the internal storage, and in a case where the algorithm is executed, executing the algorithm by using a second intermediate parameter, which is a remaining portion of the intermediate parameters other than the first intermediate parameter, and the first intermediate parameter read from the internal storage.

According to this, only a portion (the first intermediate parameter) of the intermediate parameters is stored in the internal storage device instead of storing all the intermediate parameters in the internal storage device. This is advantageous in that it is easy to reduce a usage amount of the internal storage device included in the device in a case where the algorithm using lattice-based cryptography is executed.

These general or specific aspects may be implemented as a system, a device, a method, an integrated circuit, a computer program, a computer-readable non-transitory storage medium such as a CD-ROM, or any selective combination thereof.

Embodiments are specifically described below with reference to the drawings. Note that each of the embodiments below illustrates a general or specific example. Numerical values, shapes, materials, constituent elements, the way in which the constituent elements are disposed and connected, steps, the order of steps, and the like in the embodiments below are examples and do not limit the present disclosure. Among constituent elements in the embodiments below, constituent elements that are not described in independent claims are described as optional constituent elements. Note that each drawing is a schematic view and is not necessarily strict illustration. In the drawings, substantially identical constituent elements are given identical reference signs, and repeated description thereof may be omitted or simplified.

### Embodiment

### 1. Outline

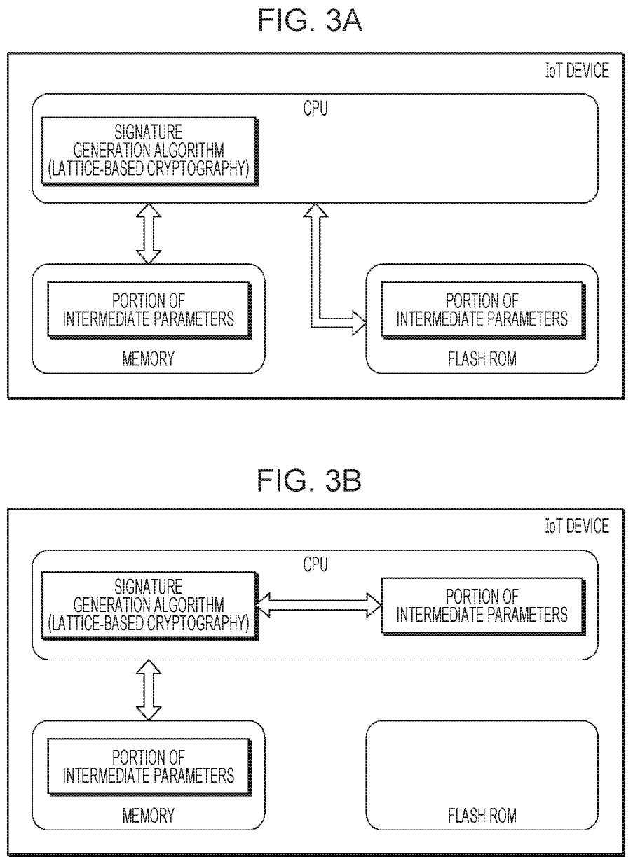

First, an outline of a cryptographic processing method (cryptographic processing system) according to an embodiment is described. FIGS. 3A and 3B are views for explaining an outline of the cryptographic processing method according to the embodiment. FIG. 3A is a view for explaining an outline of a first method of the cryptographic processing method according to the embodiment, and FIG. 3B is a view for explaining an outline of a second method of the cryptographic processing method according to the embodiment. A device (an IoT device in this example) illustrated in FIGS. 3A and 3B includes a CPU, a memory, and a flash ROM, as in the example illustrated in FIG. 1.

According to the cryptographic processing method according to the embodiment, in both the first method and the second method, first intermediate parameter, which is a portion of intermediate parameters used in an algorithm (a signature generation algorithm or a signature verification algorithm) using the lattice-based cryptography, is stored in the memory (internal storage device) of the IoT device. That is, according to the cryptographic processing method according to the embodiment, only a portion (the first intermediate parameter) of the intermediate parameters is stored in the memory instead of storing all the intermediate parameters in the memory, unlike the standard means.

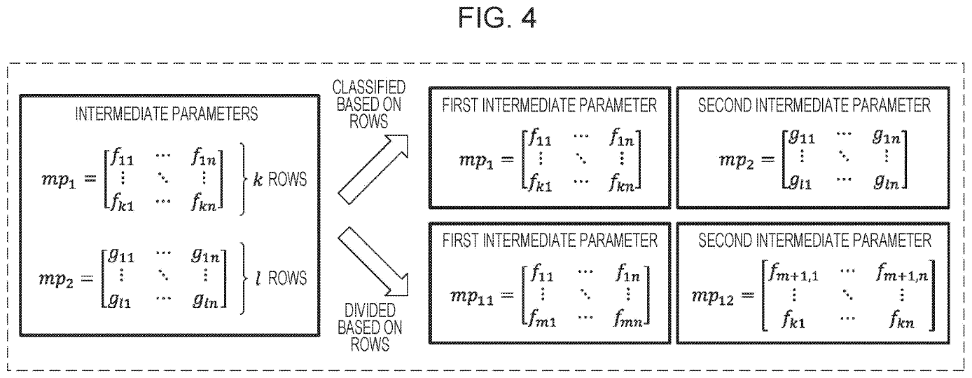

As has been described above, the intermediate parameters are represented by a matrix having elements that are polynomials over a finite field. The inventor of the present invention noted that the intermediate parameters constituted by a matrix can be classified or divided as illustrated in FIG. 4.

FIG. 4 is a view for explaining an outline of classification and division of the intermediate parameters. As illustrated in FIG. 4, the intermediate parameters include parameters mp₁, mp₂, . . . (two parameters mp₁ and mp₂ in FIG. 4) classified on the basis of the number of rows or the number of columns (the number of rows in this example). In the example illustrated in FIG. 4, the parameter mp₁ is represented by a matrix of k rows and n columns (k and n are natural numbers), and the parameter mp₂ is represented by a matrix of l rows and n columns (l is a natural number and is not equal to k).

In a case where the intermediate parameters are classified, the first intermediate parameter includes a parameter classified from among the parameters. In a case where the intermediate parameters (the parameters mp₁ and mp₂) are classified in the example illustrated in FIG. 4, the first intermediate parameter is, for example, the parameter mp₁. In this case, a second intermediate parameter different from the first intermediate parameter among the intermediate parameters is the parameter mp₂.

In a case where the intermediate parameters are divided, the first intermediate parameter includes a parameter having a predetermined number of rows or columns obtained by dividing the matrix representing the intermediate parameters. In a case where the intermediate parameters (the parameters mp₁ and mp₂) are divided in the example illustrated in FIG. 4, the first intermediate parameter is, for example, a parameter mp₁₁ represented by a matrix of m rows (m is a natural number that satisfies 1≤m<k+l) among k+l rows in total. In this case, the second intermediate parameter is a parameter (parameters mp₁₂ and mp₂) represented by a matrix of remaining k+l−m rows.

See FIGS. 3A and 3B again. In both the first method and the second method, the CPU performs processing for generating intermediate parameters when executing the signature generation algorithm or the signature verification algorithm for the first time in the IoT device. In the first method, as illustrated in FIG. 3A, the CPU classifies or divides the generated intermediate parameters into the first intermediate parameter and the second intermediate parameter, causes the first intermediate parameter to be stored in the memory (internal storage device), and causes the second intermediate parameter to be stored in the flash ROM (external storage device). Then, when executing the signature generation algorithm or the signature verification algorithm, the CPU reads out the first intermediate parameter corresponding to the algorithm from the memory and reads out the second intermediate parameter corresponding to the algorithm from the flash ROM, and thus uses the intermediate parameters.

In the second method, as illustrated in FIG. 3B, the CPU classifies or divides the intermediate parameters into the first intermediate parameter and the second intermediate parameter, and causes the first intermediate parameter to be stored in the memory (internal storage device). Then, when executing the signature generation algorithm or the signature verification algorithm, the CPU reads out the first intermediate parameter corresponding to the algorithm from the memory and generates the second intermediate parameter corresponding to the algorithm by calculation, and thus uses the intermediate parameters.

As described above, in the cryptographic processing method (cryptographic processing system) according to the embodiment, only a portion (the first intermediate parameter) of the intermediate parameters is stored in the memory instead of storing all the intermediate parameters in the memory (internal storage device). This is advantageous in that it is easy to reduce a usage amount of the memory in a case where an algorithm using the lattice-based cryptography is executed.

### 2. Preprocessing

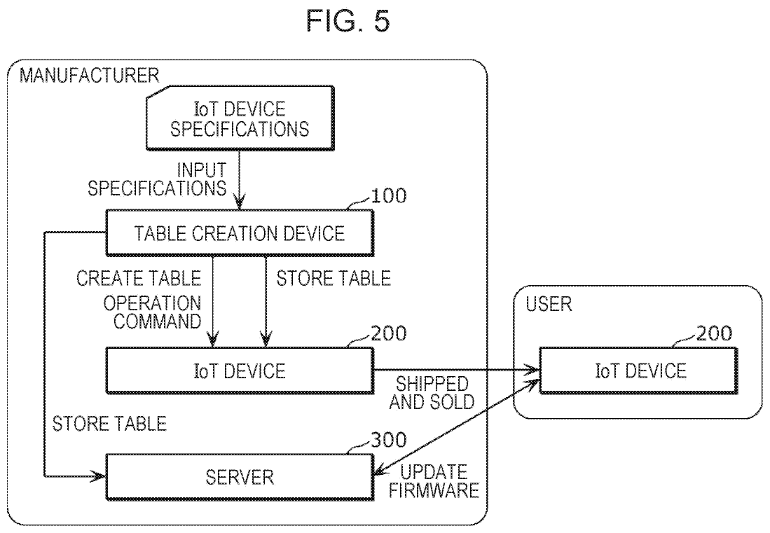

Next, preprocessing performed on the device (the IoT device in this example) in which the cryptographic processing system according to the embodiment is mounted is described. In the embodiment, processing for creating an intermediate parameter table and a processing time upper limit table by a table creation device 100 (see FIG. 5) and processing for storing the intermediate parameter table and the processing time upper limit table thus created in an IoT device 200 (see FIG. 5) are performed as the preprocessing.

The table creation device 100 is, for example, realized by an information terminal such as a personal computer, a smartphone, or a tablet terminal. The IoT device 200 is a device connectable to the Internet and is, for example, a household electrical appliance such as an air conditioner or a washing machine. Note that the IoT device 200 may be any device connectable to the Internet and is not limited to a household electrical appliance. Furthermore, the device is not limited to the IoT device 200 and can be, for example, any device that can communicate with another device over a network such as the Internet.

The intermediate parameter table is a data table showing a correlation between an amount of the portion of the intermediate parameters stored in the memory (internal storage device) or the flash ROM (external storage device), and a usage amount of the memory used to execute an algorithm using the lattice-based cryptography and a processing time required to execute the algorithm. The processing time upper limit table is a data table showing a correlation between an upper limit of a processing time required to execute the algorithm using the lattice-based cryptography and a function of executing the algorithm. Details of the intermediate parameter table and the processing time upper limit table will be described later.

FIG. 5 is a view for explaining an outline of the preprocessing. As illustrated in FIG. 5, a manufacturer that manufactures the IoT device 200 creates the intermediate parameter table and the processing time upper limit table to be stored in the IoT device 200 by inputting specifications of the IoT device 200 to the table creation device 100 when manufacturing the IoT device 200. The table creation device 100 creates the intermediate parameter table and the processing time upper limit table while causing the IoT device 200 to operate. Next, the table creation device 100 stores the created intermediate parameter table and processing time upper limit table in a storage device of the IoT device 200. At this time, the table creation device 100 also stores the created intermediate parameter table and processing time upper limit table in a server 300 that manages the IoT device 200, for example, by updating firmware used in the IoT device 200. Then, the IoT device 200 is shipped and sold, and a user obtains the IoT device 200 having the intermediate parameter table and the processing time upper limit table stored in the storage device, that is, the IoT device 200 that has been subjected to the preprocessing.

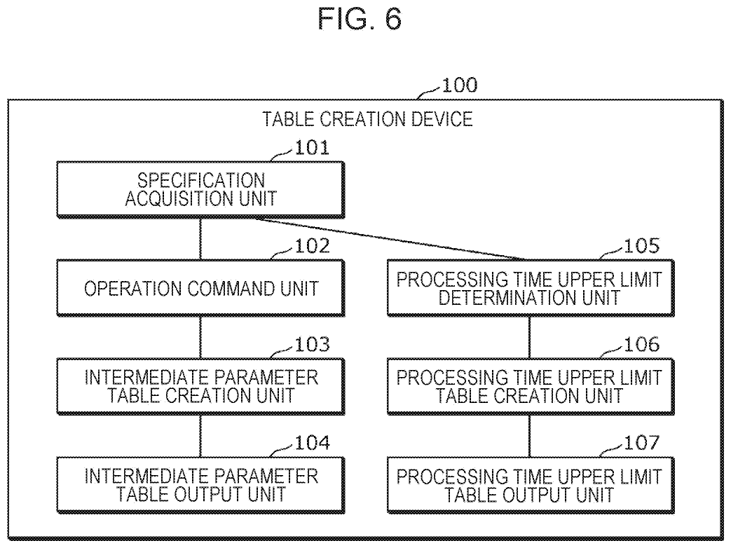

FIG. 6 is a block diagram illustrating an example of a functional configuration of the table creation device 100 according to the embodiment. The table creation device 100 includes a processor and a memory, and the processor executes a program stored in the memory and thereby the table creation device 100 realizes a function thereof. As illustrated in FIG. 6, the table creation device 100 includes a specification acquisition unit 101, an operation command unit 102, an intermediate parameter table creation unit 103, an intermediate parameter table output unit 104, a processing time upper limit determination unit 105, a processing time upper limit table creation unit 106, and a processing time upper limit table output unit 107.

The specification acquisition unit 101 receives input of the specifications of the IoT device 200. The specifications include, for example, a storage capacity of a memory (internal storage device) of the IoT device 200, a capacity of a flash ROM (external storage device), a storage capacity of a storage region using TrustZone (Registered Trademark) included in the flash ROM, and the like. Furthermore, the specifications include, for example, an intended purpose, a use environment, security requirements, and the like of the IoT device 200. The security requirements indicate a level of security (i.e., resistance against information leakage) requested for the IoT device 200.

The operation command unit 102 commands the IoT device 200 to perform a predetermined operation. The predetermined operation is processing for generating a predetermined amount of parameters among intermediate parameters. The predetermined amount is a component corresponding to several rows or a component corresponding to several columns of the matrix representing the intermediate parameters. This makes it possible to calculate a usage amount of the memory used when the predetermined amount of parameters is stored in the memory (internal storage device) included in the IoT device 200 and a processing time required for processing using the predetermined amount of parameters. The usage amount of the memory and the processing time thus calculated are referred to by the intermediate parameter table creation unit 103 as data associated with the predetermined amount of parameters. The operation command unit 102 commands the IoT device 200 to repeatedly perform the predetermined operation while changing the predetermined amount.

The intermediate parameter table creation unit 103 creates the intermediate parameter table by referring to the specifications acquired by the specification acquisition unit 101 and the data calculated by the IoT device 200 in response to the command from the operation command unit 102. In the embodiment, the intermediate parameter table creation unit 103 creates an intermediate parameter table to be referred to in the first method of the cryptographic processing method and an intermediate parameter table to be referred to in the second method of the cryptographic processing method.

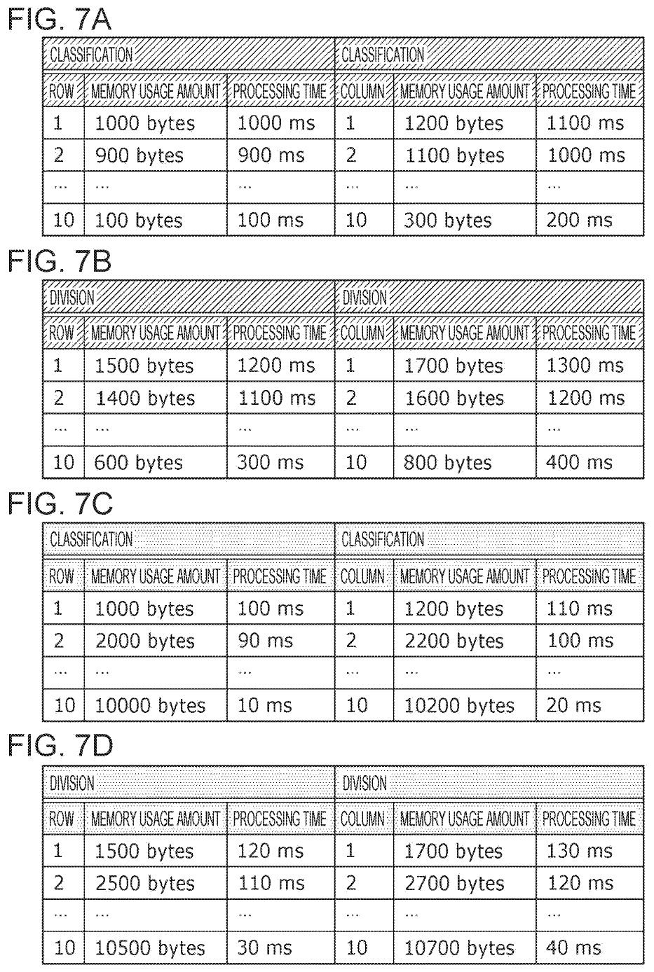

FIGS. 7A to 7D illustrate an example of the intermediate parameter table. FIG. 7A illustrates the intermediate parameter table to be referred to in a case where the first method of the cryptographic processing method is used and the intermediate parameters are classified into the first intermediate parameter and the second intermediate parameter. FIG. 7B illustrates the intermediate parameter table to be referred to in a case where the first method of the cryptographic processing method is used and the intermediate parameters are divided into the first intermediate parameter and the second intermediate parameter. FIG. 7C illustrates the intermediate parameter table to be referred to in a case where the second method of the cryptographic processing method is used and the intermediate parameters are classified into the first intermediate parameter and the second intermediate parameter. FIG. 7D illustrates the intermediate parameter table to be referred to in a case where the second method of the cryptographic processing method is used and the intermediate parameters are divided into the first intermediate parameter and the second intermediate parameter.

FIG. 7A illustrates a correlation between the number of rows (or the number of columns), and a usage amount of the memory and a processing time in a case where an intermediate parameter constituted by A rows (or A columns) among the intermediate parameters is stored in the flash ROM. A numerical value in “ROW” and “COLUMN” in FIG. 7A corresponds to “A” described above.

FIG. 7B illustrates a correlation between the number of rows (or the number of columns), and a usage amount of the memory and a processing time in a case where an intermediate parameter constituted by upper B rows (or left B columns) obtained by dividing the intermediate parameters is stored in the flash ROM. A numerical value in “ROW” and “COLUMN” in FIG. 7B corresponds to “B” described above.

FIG. 7C illustrates a correlation between the number of rows (or the number of columns), and a usage amount of the memory and a processing time in a case where an intermediate parameter constituted by C rows (or C columns) among the intermediate parameters is stored in the memory. A numerical value in “ROW” and “COLUMN” in FIG. 7C corresponds to “C” described above.

FIG. 7D illustrates a correlation between the number of rows (or the number of columns), and a usage amount of the memory and a processing time in a case where an intermediate parameter constituted by upper D rows (or left D columns) obtained by dividing the intermediate parameters is stored in the memory. A numerical value in “ROW” and “COLUMN” in FIG. 7D corresponds to “D” described above.

An example of creation of the intermediate parameter table is described below. It is assumed here that the intermediate parameters are represented by a matrix of 30 rows and 30 columns in total.

First, an example of creation of the intermediate parameter table to be referred to in the first method of the cryptographic processing method is described. In the first method, a portion of the intermediate parameters is stored in an external storage device 224, but the intermediate parameters include information on a private key of a signer, and the like. Therefore, the intermediate parameter table creation unit 103 determines a maximum amount (a maximum number of rows or a maximum number of columns) of a parameter (second intermediate parameter) that can be stored in the external storage device 224 among the intermediate parameters on the basis of the specifications of the IoT device 200, and generates the intermediate parameter table on the basis of the maximum amount thus determined.

Specifically, the intermediate parameter table creation unit 103 determines the maximum amount of the second intermediate parameter, for example, on the basis of the following calculation algorithm. It is assumed here that the maximum amount of the second intermediate parameter is the maximum number of rows. The calculation algorithm determines the maximum amount of the second intermediate parameter that satisfies the following nine conditions in total: (1) a usage amount (ROM usage amount) in a case where the second intermediate parameter is stored in the external storage device 224 is equal to or less than a storage capacity of the external storage device 224, (2) the ROM usage amount is equal to or less than a size of TrustZone (Registered Trademark), (3) the maximum number of rows is 20 or less in a case where the intended purpose of the IoT device 200 is a “household electrical appliance”, (4) the maximum number of rows is 15 or less in a case where the intended purpose of the IoT device 200 is a “camera”, (5) the maximum number of rows is 20 or less in a case where the use environment of the IoT device 200 is “indoor”, (6) the maximum number of rows is 15 or less in a case where the use environment of the IoT device 200 is “outdoor”, (7) the maximum number of rows is 20 or less in a case where the security requirements of the IoT device 200 indicate “level 1”, (8) the maximum number of rows is 15 or less in a case where the security requirements of the IoT device 200 indicate “level 2”, and (9) the maximum number of rows is 10 or less in a case where the security requirements of the IoT device 200 indicate “level 3”. Note that the intended purposes in (3) and (4) are not limited to these and may be other intended purposes, and the numerical values in (3) and (4) are not limited to these and may be other numerical values. The use environments in (5) and (6) are not limited to these and may be other use environments, and the numerical values in (5) and (6) are not limited to these and may be other numerical values. The security requirements in (7) to (9) are not limited to these and may be other requirements, and the numerical values in (7) to (9) are not limited to these and may be other numerical values.

The calculation algorithm need not determine the maximum amount of the second intermediate parameter on the basis of all of the intended purpose, use environment, and security requirements of the IoT device 200, and may determine the maximum amount of the second intermediate parameter on the basis of at least one of the intended purpose, use environment, or security requirements.

As a specific example, assume that the storage capacity of the external storage device 224 is 100 MB, the size of TrustZone (Registered Trademark) is 50 MB, the intended purpose of the IoT device 200 is a “household electrical appliance”, the use environment of the IoT device 200 is “outdoor”, and the security requirements of the IoT device 200 indicate “level 1”. Furthermore, assume that the ROM usage amount increases by 5 MB every time one row of the parameters is stored in the external storage device 224. In this case, the intermediate parameter table creation unit 103 determines that the maximum amount (the maximum number of rows in this example) of the second intermediate parameter is 10 and creates the intermediate parameter table on the basis of the maximum amount of the second intermediate parameter thus determined.

Next, an example of creation of the intermediate parameter table to be referred to in the second method of the cryptographic processing method is described. In the second method, a portion (the first intermediate parameter) of the intermediate parameters is stored in an internal storage device 223, and a remaining portion (the second intermediate parameter) of the intermediate parameters is calculated at a time of execution of the algorithm. The storage capacity of the internal storage device 223 differs from one IoT device to another, and a parameter that uses a larger storage capacity than the storage capacity of the internal storage device 223 cannot be stored in the internal storage device 223. Accordingly, the intermediate parameter table creation unit 103 determines a maximum amount (a maximum number of rows or a maximum number of columns) of the parameter (the first intermediate parameter) that can be stored in the internal storage device 223 among the intermediate parameters on the basis of the specifications of the IoT device 200 (especially the storage capacity of the internal storage device 223 included in the IoT device 200), and creates the intermediate parameter table on the basis of the determined maximum amount.

Specifically, the intermediate parameter table creation unit 103 determines the maximum amount of the first intermediate parameter, for example, on the basis of the following calculation algorithm. It is assumed here that the maximum amount of the first intermediate parameter is the maximum number of rows. The calculation algorithm determines the maximum amount of the first intermediate parameter that satisfies a condition that a usage amount of the memory in a case where the first intermediate parameter is stored in the internal storage device 223 is equal to or less than the storage capacity of the internal storage device 223.

As a specific example, it is assumed that the storage capacity of the internal storage device 223 is 10000 bytes. Furthermore, it is assumed that the usage amount of the memory increases by 1000 bytes every time one row of the parameters is stored in the internal storage device 223. In this case, the intermediate parameter table creation unit 103 determines that the maximum amount of the first intermediate parameter (the maximum number of rows in this example) is 10 rows, and creates the intermediate parameter table on the basis of the maximum amount of the first intermediate parameter thus determined.

The intermediate parameter table output unit 104 outputs the intermediate parameter table created by the intermediate parameter table creation unit 103. In the embodiment, the intermediate parameter table output unit 104 outputs the intermediate parameter table to the IoT device 200 and the server 300.

The processing time upper limit determination unit 105 determines an upper limit of a processing time in each function executed by the IoT device 200 on the basis of the specifications acquired by the specification acquisition unit 101.

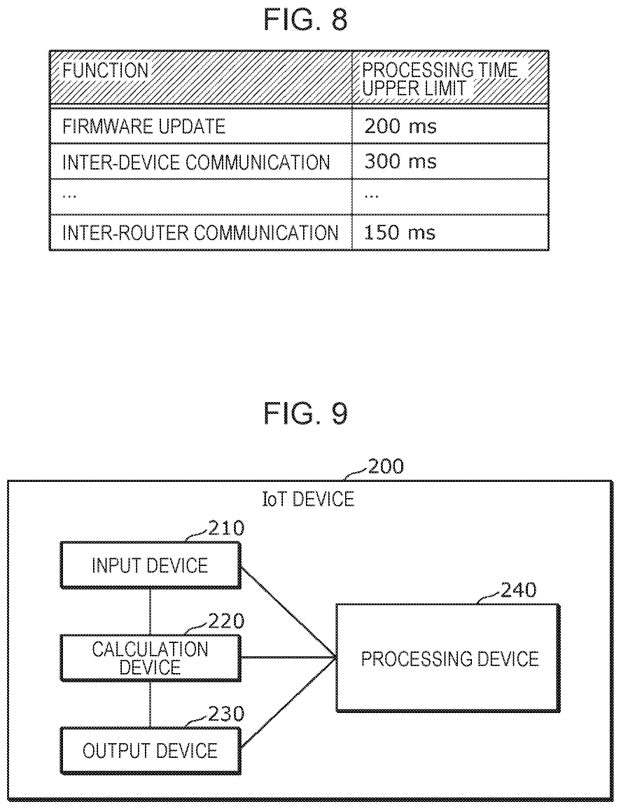

The processing time upper limit table creation unit 106 creates the processing time upper limit table on the basis of the upper limit of the processing time in each function determined by the processing time upper limit determination unit. FIG. 8 illustrates an example of the processing time upper limit table. In the example illustrated in FIG. 8, the processing time upper limit table shows an upper limit of a processing time in a “firmware update” function, an upper limit of a processing time in an “inter-device communication” function, and an upper limit of a processing time in an “inter-router communication” function. The “firmware update” function is a function of executing an algorithm (the signature generation algorithm in this example) using the lattice-based cryptography at a time of update of firmware. The “inter-device communication” function is a function of executing the algorithm using the lattice-based cryptography at a time of communication with another device. The “inter-router communication” function is a function of executing the algorithm using the lattice-based cryptography at a time of communication with a router.

The processing time upper limit table output unit 107 outputs the processing time upper limit table created by the processing time upper limit table creation unit 106. In the embodiment, the processing time upper limit table output unit 107 outputs the processing time upper limit table to the IoT device 200 and the server 300.

### 3. Configuration

Next, an overall configuration including the cryptographic processing system according to the embodiment is described. In the embodiment, a calculation device 220 included in the IoT device 200 corresponds to the cryptographic processing system. FIG. 9 is a block diagram illustrating an example of a functional configuration of the IoT device 200 according to the embodiment. As illustrated in FIG. 9, the IoT device 200 includes an input device 210, the calculation device 220, an output device 230, and a processing device 240.

In a case where a message is transmitted to another device, the input device 210 receives input of data concerning the message. In the embodiment, the input device 210 receives input of the message, a private key corresponding to the message, and information indicative of a function corresponding to the message. In a case where a message is received from another device, the input device 210 acquires data concerning the message. In the embodiment, the input device 210 acquires the message, a public key corresponding to the message, a signature corresponding to the message, and information indicative of a function corresponding to the message.

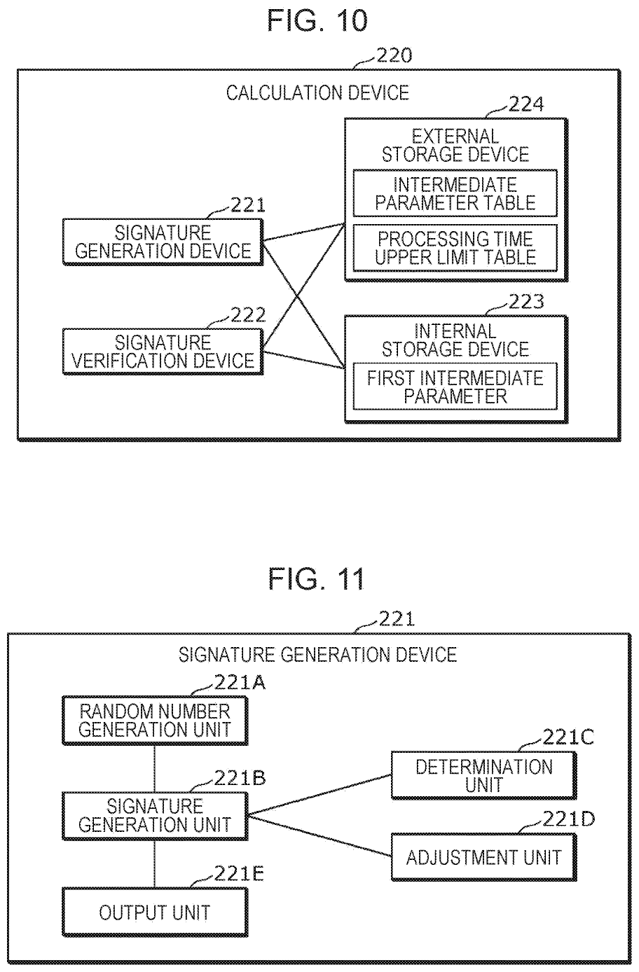

The calculation device 220 includes, for example, a processor such as a CPU and a memory, and the processor executes a program stored in the memory and thereby the calculation device 220 realizes a function thereof. The calculation device 220 executes various algorithms using the lattice-based cryptography. In the embodiment, the calculation device 220 is configured to be capable of executing the signature generation algorithm and the signature verification algorithm. FIG. 10 is a block diagram illustrating an example of a functional configuration of the cryptographic processing system (the calculation device 220) according to the embodiment. As illustrated in FIG. 10, the calculation device 220 includes a signature generation device 221, a signature verification device 222, the internal storage device 223, and the external storage device 224.

The signature generation device 221 generates a signature for a message received by the input device 210 by executing the signature generation algorithm using the lattice-based cryptography. FIG. 11 is a block diagram illustrating an example of a functional configuration of the signature generation device 221 according to the embodiment. As illustrated in FIG. 11, the signature generation device 221 includes a random number generation unit 221A, a signature generation unit 221B, a determination unit 221C, an adjustment unit 221D, and an output unit 221E.

The random number generation unit 221A generates a random number, for example, by executing an appropriate random number generation algorithm by using a random seed stored in advance in the internal storage device 223.

The signature generation unit 221B generates a signature by executing the signature generation algorithm using the lattice-based cryptography by using the random number generated by the random number generation unit 221A.

In the embodiment, in a case where the first method of the cryptographic processing method is used, the signature generation unit 221B executes the signature generation algorithm by using the intermediate parameters (the first intermediate parameter and the second intermediate parameter) obtained by reading out the first intermediate parameter from the internal storage device 223 and reading out the second intermediate parameter from the external storage device 224. In a case where the second method of the cryptographic processing method is used, the signature generation unit 221B executes the signature generation algorithm by using the intermediate parameters (the first intermediate parameter and the second intermediate parameter) obtained by reading out the first intermediate parameter from the internal storage device 223 and calculating the second intermediate parameter.

The determination unit 221C determines how to partition the intermediate parameters into the first intermediate parameter and the second intermediate parameter. In the embodiment, the determination unit 221C determines the first intermediate parameter and the second intermediate parameter on the basis of a processing capability of the IoT device 200 and an available storage capacity of the internal storage device 223. Specifically, the determination unit 221C acquires the storage capacity available in the internal storage device 223 (hereinafter referred to as an “available memory amount”), for example, in response to a command from an Operating System (OS) before executing the signature generation algorithm. Furthermore, the determination unit 221C acquires an upper limit of a processing time in a function of executing the signature generation algorithm by referring to the processing time upper limit table stored in the external storage device 224 before executing the signature generation algorithm.

Then, the determination unit 221C further acquires the intermediate parameter table stored in the external storage device 224, and determines the first intermediate parameter and the second intermediate parameter, for example, on the basis of the following determination algorithm. The determination algorithm determines, as the first intermediate parameter, a parameter that satisfies the following seven conditions in total: (1) the memory usage amount is smaller than the available memory amount, (2) the processing time is shorter than the upper limit of the processing time, (3) classification is given priority over division, (4) partition based on rows is given priority over partition based on columns, (5) use of the first method is given priority over use of the second method, (6) data that uses a smaller memory amount is selected from the intermediate parameter table, and (7) data that requires a shorter processing time is selected from the intermediate parameter table, and determines a remaining parameter as the second intermediate parameter. Note that in at least one of the conditions (3), (4), or (5), what is given priority may be reverse to that described above. For example, the condition (3) may be a condition that division is given priority over classification.

As a specific example, it is assumed that the available memory amount is 1000 bytes and the upper limit of the processing time is 200 ms. In this case, the determination unit 221C determines, as the first intermediate parameter, a parameter corresponding to upper ten rows obtained by classifying the intermediate parameters on the basis of the conditions (1), (2), (6), and (7) by referring to the intermediate parameter table illustrated in FIG. 7A on the basis of the conditions (3), (4), and (5), and determines a remaining parameter as the second intermediate parameter.

The adjustment unit 221D adjusts the intermediate parameters on the basis of the method determined by the determination unit 221C. In the embodiment, the adjustment unit 221D classifies or divides the intermediate parameters to obtain the first intermediate parameter by the method determined by the determination unit 221C and determines a remaining intermediate parameter as the second intermediate parameter. In a case where the determination unit 221C determines that the first method of the cryptographic processing method is used, the adjustment unit 221D causes the first intermediate parameter to be stored in the internal storage device 223 and causes the second intermediate parameter to be stored in the external storage device 224. In a case where the determination unit 221C determines that the second method of the cryptographic processing method is used, the adjustment unit 221D causes the first intermediate parameter to be stored in the internal storage device 223.

The output unit 221E outputs the signature generated by the signature generation unit 221B. In the embodiment, the output unit 221E outputs the signature generated by the signature generation unit 221B to the output device 230 in association with the message received by the input device 210.

The signature verification device 222 verifies a signature corresponding to a message received by the input device 210 by executing the signature verification algorithm using the lattice-based cryptography. In the embodiment, in a case where the first method of the cryptographic processing method is used, the signature verification device 222 executes the signature verification algorithm by using the intermediate parameters (the first intermediate parameter and the second intermediate parameter) obtained by reading out the first intermediate parameter from the internal storage device 223 and reading out the second intermediate parameter from the external storage device 224. In a case where the second method of the cryptographic processing method is used, the signature verification device 222 executes the signature verification algorithm by using the intermediate parameters (the first intermediate parameter and the second intermediate parameter) obtained by reading out the first intermediate parameter from the internal storage device 223 and calculating the second intermediate parameter. Note that how to partition the intermediate parameters into the first intermediate parameter and the second intermediate parameter is similar to the signature generation device 221, and therefore description thereof is omitted.

The internal storage device 223 is a storage device built in the IoT device 200 and is, for example, a SRAM, a DRAM, or the like. In the embodiment, the internal storage device 223 corresponds to a memory of the calculation device 220. The internal storage device 223 stores therein the first intermediate parameter among the intermediate parameters. Furthermore, the internal storage device 223 stores therein a random seed to be used by the random number generation unit 221A.

The external storage device 224 is an external storage device connected to the IoT device 200 and is, for example, a flash ROM or the like. In the embodiment, the external storage device 224 stores therein the intermediate parameter table and the processing time upper limit table. Furthermore, in a case where the first method of the cryptographic processing method is used, the external storage device 224 further stores therein the second intermediate parameter among the intermediate parameters.

In a case where a message is transmitted to another device, the output device 230 transmits the message with a signature generated by the signature generation device 221 to the device, and thus outputs the signature. In a case where the IoT device 200 includes a display, the output device 230 displays the signature on the display. In a case where a message is received from another device, the output device 230 outputs a result of verification in the signature verification device 222 to the processing device 240. In a case where the IoT device 200 includes a display, the output device 230 displays the verification result on the display.

The processing device 240 includes a processor and a memory, and the processor executes a program stored in the memory and thereby the processing device 240 realizes a function thereof. The processing device 240 performs various kinds of processing concerning the whole IoT device 200. For example, in a case where a message is received from another device, the processing device 240 determines whether or not to discard the message on the basis of a verification result output from the output device 230. For example, in a case where the verification result indicates that the signature is false, the processing device 240 discards the message.

### 4. Operation

An example of operation of the IoT device 200 according to the embodiment is described.

### 4-1. First Example of Operation

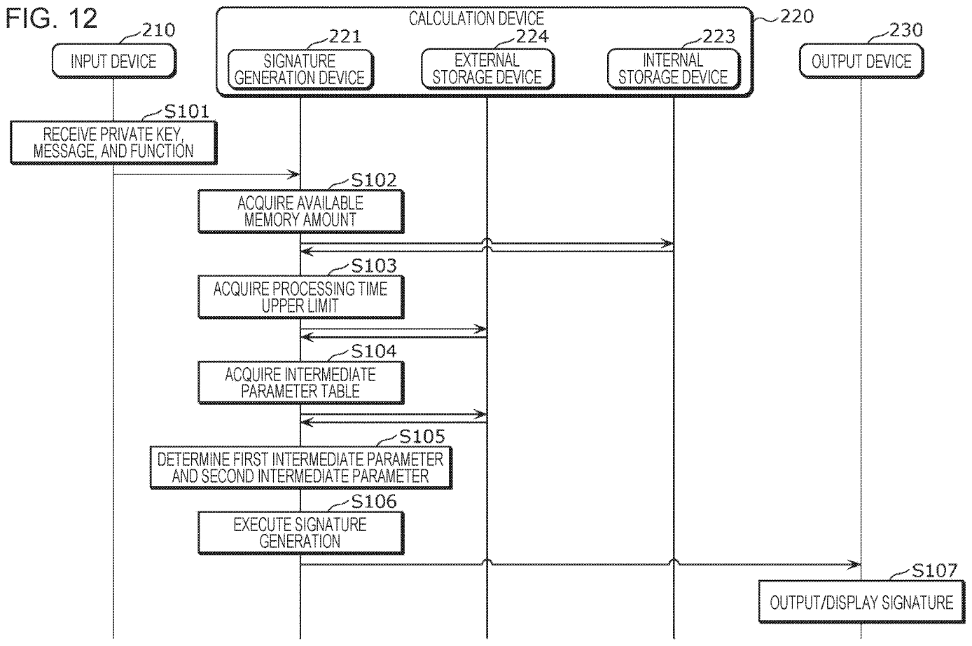

FIG. 12 is a sequence diagram illustrating a first example of operation of the IoT device 200 according to the embodiment. The first example of operation is performed in a case where the IoT device 200 transmits a message to another device.

First, the input device 210 receives input of data concerning the message to be transmitted. In this example, the input device 210 receives input of the message, a private key corresponding to the message, and information indicative of a function corresponding to the message (S101).

Next, the signature generation device 221 of the calculation device 220 acquires an available storage capacity of the internal storage device 223 (available memory amount), for example, in response to a command from the OS before executing the signature generation algorithm (S102). Furthermore, the signature generation device 221 acquires an upper limit of a processing time by referring to the processing time upper limit table stored in the external storage device 224 before executing the signature generation algorithm (S103). Furthermore, the signature generation device 221 acquires the intermediate parameter table stored in the external storage device 224 before executing the signature generation algorithm (S104).

Next, the signature generation device 221 determines the first intermediate parameter and the second intermediate parameter on the basis of the determination algorithm by referring to the available memory amount, the upper limit of the processing time, and the intermediate parameter table thus acquired (S105). Then, the signature generation device 221 generates the signature by executing the signature generation algorithm (S106). As has been described above, in the embodiment, in a case where the first method of the cryptographic processing method is used, the signature generation device 221 executes the signature generation algorithm by using the intermediate parameters (the first intermediate parameter and the second intermediate parameter) obtained by reading out the first intermediate parameter from the internal storage device 223 and reading out the second intermediate parameter from the external storage device 224. In a case where the second method of the cryptographic processing method is used, the signature generation device 221 executes the signature generation algorithm by using the intermediate parameters (the first intermediate parameter and the second intermediate parameter) obtained by reading out the first intermediate parameter from the internal storage device 223 and calculating the second intermediate parameter.

Then, the output device 230 transmits the message with the signature generated by the signature generation device 221 to another device, and thus outputs the signature (S107). In a case where the IoT device 200 includes a display, the output device 230 displays the signature on the display (S107).

### 4-2. Second Example of Operation

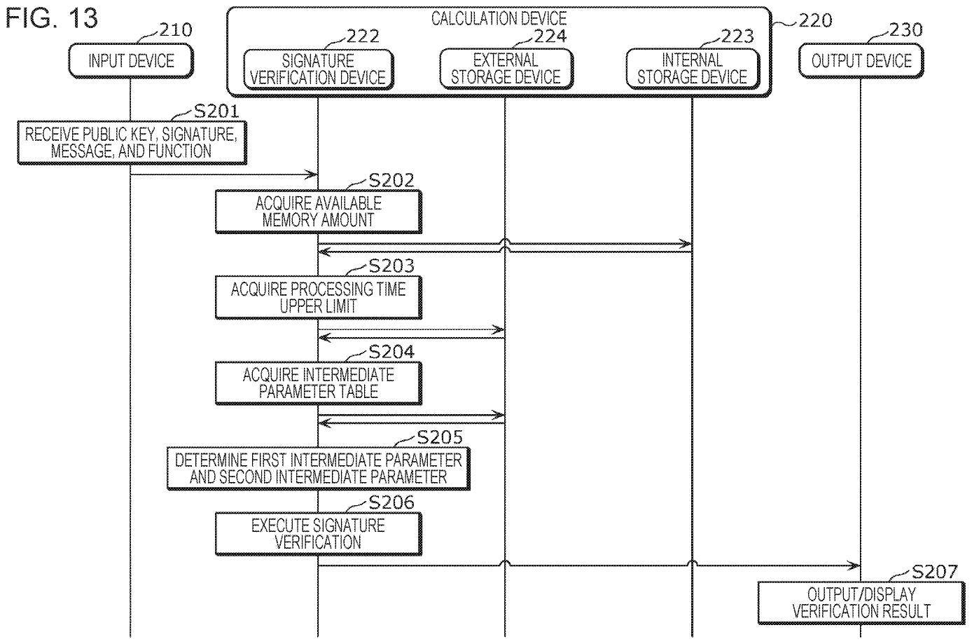

FIG. 13 is a sequence diagram illustrating a second example of operation of the IoT device 200 according to the embodiment. The second example of operation is performed in a case where the IoT device 200 receives a message from another device.

First, the input device 210 acquires data concerning the received message. In this example, the input device 210 acquires the message, a public key corresponding to the message, a signature corresponding to the message, and information indicative of a function corresponding to the message (S201).

Next, the signature verification device 222 of the calculation device 220 acquires the available storage capacity of the internal storage device 223 (available memory amount), for example, in response to a command from the OS before executing the signature verification algorithm (S202). Furthermore, the signature verification device 222 acquires an upper limit of a processing time by referring to the processing time upper limit table stored in the external storage device 224 before executing the signature verification algorithm (S203). Furthermore, the signature verification device 222 acquires the intermediate parameter table stored in the external storage device 224 before executing the signature verification algorithm (S204).

Next, the signature verification device 222 determines the first intermediate parameter and the second intermediate parameter on the basis of the determination algorithm by referring to the available memory amount, the upper limit of the processing time, and the intermediate parameter table thus acquired (S205). Then, the signature verification device 222 verifies the signature by executing the signature verification algorithm (S206). As has been described above, in the embodiment, in a case where the first method of the cryptographic processing method is used, the signature verification device 222 executes the signature verification algorithm by using the intermediate parameters (the first intermediate parameter and the second intermediate parameter) obtained by reading out the first intermediate parameter from the internal storage device 223 and reading out the second intermediate parameter from the external storage device 224. In a case where the second method of the cryptographic processing method is used, the signature verification device 222 executes the signature verification algorithm by using the intermediate parameters (the first intermediate parameter and the second intermediate parameter) obtained by reading out the first intermediate parameter from the internal storage device 223 and calculating the second intermediate parameter.

Then, the output device 230 outputs a verification result obtained by the signature verification device 222 (S207). In a case where the IoT device 200 includes a display, the output device 230 displays the verification result on the display (S207).

### 5. Advantages

Advantages of the cryptographic processing method (cryptographic processing system) according to the embodiment are described below. As described above, in the cryptographic processing method according to the embodiment, the first intermediate parameter, which is a portion of the intermediate parameters used to execute an algorithm using the lattice-based cryptography, is stored in advance in the internal storage device 223, and in a case where the algorithm is executed, the algorithm is executed by using the first intermediate parameter read from the internal storage device 223 and the second intermediate parameter, which is a remaining portion of the intermediate parameters.

According to the cryptographic processing method according to the embodiment, only a portion (the first intermediate parameter) of the intermediate parameters is stored in the internal storage device 223 instead of storing all the intermediate parameters in the internal storage device 223. This is advantageous in that it is easy to reduce a usage amount of the internal storage device 223 included in the device (the IoT device 200) in a case where the algorithm using the lattice-based cryptography is executed.

According to the first method of the cryptographic processing method according to the embodiment, a parameter for which information leakage is not permitted such as information on a private key of a signer among the intermediate parameters can be stored in the internal storage device 223, and a remaining parameter can be stored in the external storage device 224. Therefore, the first method is advantageous in that it is easy to improve resistance against information leakage while reducing a usage amount of the internal storage device 223 as compared with the first means disclosed in Denisa.

According to the second method of the cryptographic processing method according to the embodiment, only a portion of the intermediate parameters is calculated when executing the algorithm instead of calculating all the intermediate parameters. Therefore, the second method is advantageous in that it is easy to shorten a processing time of processing for calculating the intermediate parameter while reducing a usage amount of the internal storage device 223 as compared with the second means disclosed in Denisa.

### Other Embodiments

Although the embodiment has been described above, the present disclosure is not limited to the above embodiment.

In the above embodiment, the signature generation algorithm and the signature verification algorithm may be different in how to partition the intermediate parameters into the first intermediate parameter and the second intermediate parameter. Specifically, the intermediate parameter table and the processing time upper limit table referred to when executing the signature generation algorithm may be different from the intermediate parameter table and the processing time upper limit table referred to when executing the signature verification algorithm.

In the above embodiment, a process performed by a certain process unit may be performed by another process unit. The order of multiple processes may be changed, and multiple processes may be performed in parallel.

In the above embodiment, each constituent element may be implemented by executing a software program suitable for the constituent element. Each constituent element may also be implemented by a program execution unit, such as a processor (e.g., a CPU), reading and executing a software program recorded on a recording medium such as a hard disk or a semiconductor memory.

Each constituent element may be implemented by hardware. For example, each constituent element may be a circuit (or an integrated circuit). These circuits may constitute a single circuit as a whole or may be separate circuits. Each of these circuits may be a general-purpose circuit or may be a dedicated circuit.

The general or specific aspects of the present disclosure may be implemented by an apparatus, a method, an integrated circuit, a computer program, a computer-readable recording medium such as a CD-ROM, or any combination thereof.

For example, the present disclosure may be implemented as a cryptographic processing method executed by a computer or may be implemented as a program causing a computer to execute the cryptographic processing method. The present disclosure may be implemented as a computer-readable non-transitory recording medium storing such a program.

Various modifications of the embodiment that may be conceived by those skilled in the art, as well as embodiments realized by combining any of the constituent elements and functions described in the above embodiment without departing from the spirit of the present disclosure, are also encompassed within the present disclosure.

The present disclosure is useful for cryptographic communication of a device.

What is claimed is:

1. A cryptographic processing method comprising:
storing a first intermediate parameter, which is a portion of intermediate parameters used in a process of executing an algorithm using lattice-based cryptography, in an internal storage included in a device; and
in a case where the algorithm is executed, executing the algorithm by using a second intermediate parameter, which is a remaining portion of the intermediate parameters other than the first intermediate parameter, and the first intermediate parameter read from the internal storage.

2. The cryptographic processing method according to claim 1, wherein
the intermediate parameters are represented by a matrix having elements that are polynomials over a finite field and include parameters classified on a basis of the number of rows or the number of columns, and
the first intermediate parameter includes a parameter classified from among the parameters.

3. The cryptographic processing method according to claim 1, wherein
the intermediate parameters are represented by a matrix having elements that are polynomials over a finite field, and
the first intermediate parameter includes a parameter having a predetermined number of rows or columns obtained by dividing the matrix representing the intermediate parameters.

4. The cryptographic processing method according to claim 1, further comprising storing the second intermediate parameter in an external storage connected to the device, wherein
in the case where the algorithm is executed, the second intermediate parameter is read from the external storage.

5. The cryptographic processing method according to claim 1, wherein
in the case where the algorithm is executed, the second intermediate parameter is generated by calculation.

6. The cryptographic processing method according to claim 1, further comprising determining the first intermediate parameter and the second intermediate parameter on a basis of a processing capability of the device and an available storage capacity of the internal storage.

7. The cryptographic processing method according to claim 6, wherein
the first intermediate parameter and the second intermediate parameter are determined by referring to an intermediate parameter table, and
the intermediate parameter table shows a correlation between an amount of the portion of the intermediate parameters stored in either the internal storage or an external storage connected to the device, and a usage amount of the internal storage used to execute the algorithm and a processing time required to execute the algorithm.

8. The cryptographic processing method according to claim 7, further comprising:
determining a maximum amount of the parameter storable in either the internal storage or the external storage on a basis of at least one of an intended purpose of the device, a use environment of the device, or security requirements indicative of a level of security requested for the device; and
creating the intermediate parameter table on a basis of the determined maximum amount of the parameter.

9. A computer-readable non-transitory recording medium storing a program causing one or more processors to execute the cryptographic processing method according to claim 1.

10. A cryptographic processing system comprising:
an internal storage; and
a processor, wherein the processor performs operations including:
storing a first intermediate parameter, which is a portion of intermediate parameters used in a process of executing an algorithm using lattice-based cryptography, in the internal storage; and
in a case where the algorithm is executed, executing the algorithm by using a second intermediate parameter, which is a remaining portion of the intermediate parameters other than the first intermediate parameter, and the first intermediate parameter read from the internal storage.
